(19) United States
(12) Patent Application Publication
(10) Pub. No.: US 2019/0378320 A1
(43) Pub. Date: Dec. 12, 2019

(54) METHOD OF TRANSMITTING SCREEN OF VIRTUAL MACHINE USING HARDWARE-BASED GPU AND APPARATUS USING THE SAME

(71) Applicant: ELECTRONICS AND TELECOMMUNICATIONS RESEARCH INSTITUTE, Daejeon (KR)

(72) Inventors: Jong Hwan KIM, Daejeon (KR); Kee Seong CHO, Daejeon (KR)

(21) Appl. No.: 16/424,260

(22) Filed: May 28, 2019

(30) Foreign Application Priority Data
Jun. 8, 2018 (KR) 10-2018-0065863

(51) Int. Cl. G06T 15/00; G06F 9/455; G06T 1/20; H04L 29/08; H04N 19/87; H04N 19/42

(52) U.S. Cl. CPC G06T 15/005; G06F 9/45558; G06T 1/20; H04L 67/16; H04L 67/42; H04N 19/42; G06F 2009/45595; G06T 2200/16; H04N 19/87

(57) ABSTRACT

The present invention relates to a method of transmitting a screen of a virtual machine using a hardware-based graphic processing unit (GPU) and an apparatus using the same, by which the hardware-based GPU is virtualized and thus the screen of the virtual machine (VM) is efficiently transmitted. A method of transmitting a screen of a virtual machine using a hardware-based GPU according to the present invention includes checking whether a client is connected or not and whether or not the connected client makes a request for VM screen transmission; checking whether or not the screen is changed when the connected client makes the request for the VM screen transmission; performing screen capture every a predetermined screen capture time when the screen is changed, and waiting until the screen is changed when there is no screen change; and transmitting the captured screen using video compression and encoding.

### CROSS-REFERENCE TO RELATED APPLICATIONS

The present application claims priority to Korean Patent Application No. 10-2018-0065863, filed Jun. 8, 2018, the entire contents of which is incorporated herein for all purposes by this reference.

### BACKGROUND OF THE INVENTION

### Field of the Invention

The present invention generally relates to a method of transmitting a screen of a virtual machine using a hardware-based graphic processing unit (GPU) and an apparatus using the same, by which the hardware-based GPU is virtualized and thus the screen of the virtual machine (VM) is efficiently transmitted.

### Description of the Related Art

As cloud technology has matured and commercial realization has expanded, a cloud virtualization platform-based virtual desktop infrastructure (VDI) has also been realized.

In general, the cloud-based VDI service has a structure as shown in FIG. 1. In FIG. 1, a remote user 120 accesses a remote connection server 101 and receives a screen of a virtual machine (VM) 100. In FIG. 1, a hypervisor 102 serves to operate the remote connection server 101 and virtually emulate hardware such as a CPU, a GPU, and a network interface card (NIC) used by the virtual machine 100.

Herein, when the remote connection server 101 transmits the screen of the virtual machine 100 to the remote user 120, the remote connection server 101 collects the screen rendering command executed by the virtual machine from the emulated GPU, and the remote connection server 101 directly draws the corresponding screen and then transmits the same to the user. However, there are limitations to such operation. Because GPU emulating is performed on the basis of a high-level software, tasks that require high-level GPU processing, such as 3D rendering, will be very inefficient. Therefore, in the related art, functions that require high performance, such as 3D rendering, are generally not supported by software-based virtual GPUs.

In this regard, recently, hardware-based GPU virtualization (HW GPU virtualization) has been introduced to solve the above-described problems in the related art. The HW GPU virtualization technology refers to connecting the actual hardware GPU so that virtual machine 100 may use the actual hardware GPU, rather than creating a virtual GPU emulated in a software manner.

However, since the HW GPU virtualization method does not use the GPU emulating in the hypervisor but uses hardware corresponding to the actual GPU in the virtual machine, it is almost impossible to fetch the rendering command of the corresponding GPU from the hypervisor. Therefore, with the virtual screen transmission method described above, the hardware-based GPU restrictively transmits the screen of the virtual machine.

### SUMMARY OF THE INVENTION

Accordingly, the present invention has been made keeping in mind the above problems occurring in the related art, and an object of the present invention is to provide a virtual screen transmission apparatus and method for efficiently transmitting a screen of a virtual machine (VM) in which a HW GPU is virtualized.

It is also an object of the present invention to provide a virtual screen transmission apparatus and method for performing screen transmission adaptively according to whether a screen changes or not when a screen of a virtual machine (VM) is transmitted.

It is also an object of the present invention to provide a virtual screen transmission apparatus and method for transmitting a virtual screen of a virtual machine to a user by reusing a remote server without using a network of a virtual machine having security risk when providing a virtual service.

Other objects and advantages of the present invention will be apparent from the following description and more clearly understood by the embodiments of the present invention. It will also be readily apparent that the objects and advantages of the invention may be realized by means and combinations thereof pointed out in the appended claims.

In order to achieve the above objects, a method of transmitting a screen of a virtual machine using a hardware-based GPU according to an embodiment of the present invention includes checking whether a client is connected or not and whether or not the connected client makes a request for VM screen transmission; checking whether or not the screen is changed when the connected client makes the request for the VM screen transmission; performing screen capture every a predetermined screen capture time (T) when the screen is changed and a change rate per second of the corresponding screen is equal to or greater than a predetermined specific integer value (N), or waiting until the screen is changed when there is no screen change; and transmitting the captured screen using video compression and encoding.

In addition, the method may further includes performing switching to an image mode, by which whenever an original screen is changed, the corresponding screen image is transmitted as it is, when the change rate per second of the corresponding screen is less than the predetermined specific integer value (N).

In addition, the transmitting of the captured screen using video compression and encoding may be provided such that, when the number of frames that is not yet transmitted and stored in a buffer storing video compression frames is equal to or greater than a predetermined specific integer value (B), the predetermined screen capture time (T) is increased by M times, and when there is no frames stored in the buffer and the predetermined screen capture time (T) is larger than a predetermined reference value (T0), the screen capture time (T) is reduced by a predetermined unit. Herein, the predetermined unit may be set as one.

In addition, the checking of whether or not the screen is changed may be performed after the predetermined capture time (T) or more elapses from a time when a previous screen is captured.

In order to achieve the above objects, a method of transmitting a screen of a virtual machine (VM) using a hardware-based GPU according to another embodiment of the present invention includes creating a separate virtualized network interface card (VM NIC) for virtual screen transmission in the virtual machine; when creating a virtual network between the separate virtualized network interface card (VM NIC) in the virtual machine and a host network interface card (NIC) of a device in which the virtual machine is installed, setting network forwarding between the host NIC and the VM NIC in the corresponding network; checking whether a client is connected or not and whether or not the connected client makes a request for VM screen transmission; and transmitting the VM screen according to the set network forwarding, when the connected client makes the request for the VM screen transmission.

In addition, the setting of the network forwarding may be performed without using an external network of the virtual machine having security risk.

In addition, the setting of the network forwarding may be performed without using a public IP allocated to the virtualized network interface card (NIC) in the virtual machine.

In addition, the setting of the network forwarding may use a port forwarding function supported by a hypervisor in the virtual machine.

In addition, the transmitting of the VM screen may include when the connected client makes the request for the VM screen transmission, checking whether or not the screen is changed; performing screen capture every a predetermined screen capture time when the screen is changed, and waiting until the screen is changed when there is no screen change; and performing video compression and encoding on the captured screen and transmitting the screen of the compressed and encoded video according to the set network forwarding.

In order to achieve the above objects, a method of transmitting a screen of a virtual machine (VM) using a hardware-based GPU according to still another embodiment of the present invention includes checking whether a client is connected or not and whether or not the connected client makes a request for VM screen transmission; and when the connected client makes the request for the VM screen transmission, selecting any one of an optimal encoding mode (first mode), a host IP mode (second mode), and a mixed transmission mode (third mode) as a VM screen transmission mode.

In addition, the optimal encoding mode (first mode) may be provided by, when the connected client makes the request for the VM screen transmission, repeating procedures of checking whether the screen is changed, performing screen capture every a predetermined screen capture time (T) when the screen is changed, and waiting until the screen is changed when there is no screen change, so that the only captured screen is transmitted using video compression and encoding.

In addition, the hosp IP mode (second mode) may be provided by setting network forwarding between a virtualized network interface card (NIC) in the virtual machine and a host network interface card (NIC) of a device in which the virtual machine is installed, and transmitting the VM screen according to the set network forwarding when the connected client makes the request for VM screen transmission.

In addition, the mixed transmission mode (third mode) is provided by setting network forwarding between a virtualized network interface card (NIC) in the virtual machine and a host network interface card (NIC) of a device in which the virtual machine is installed, repeating procedures of checking whether the screen is changed or not, performing screen capture every a predetermined screen capture time (T) when the screen is changed, and waiting until the screen is changed when there is no screen change when the connected client makes the request for the VM screen transmission, and performing video compression and encoding on the captured screen and transmitting the screen of the compressed and encoded video according to the set network forwarding.

In addition, the selecting of the VM screen transmission mode is performed by determining the VM screen transmission mode according to an amount of data to be transmitted.

In order to achieve the above objects, an apparatus for transmitting a screen of a virtual machine according to an embodiment of the present invention includes a hardware GPU providing graphic data and a virtual machine execution unit virtualizing the hardware-based GPU and transmitting the screen of the virtual machine consisting of the virtualized hardware-based GPU data to a client connected remotely, wherein the virtual machine execution unit checks whether a client is connected or not and whether or not the connected client makes a request for VM screen transmission; checks whether or not the screen is changed when the connected client makes the request for the VM screen transmission; performs screen capture every a predetermined screen capture time when the screen is changed, and waits until the screen is changed when there is no screen change; and transmits the captured screen using video compression and encoding.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 illustrates a virtual machine (VM) screen transmission method in a VDI system in the related art;

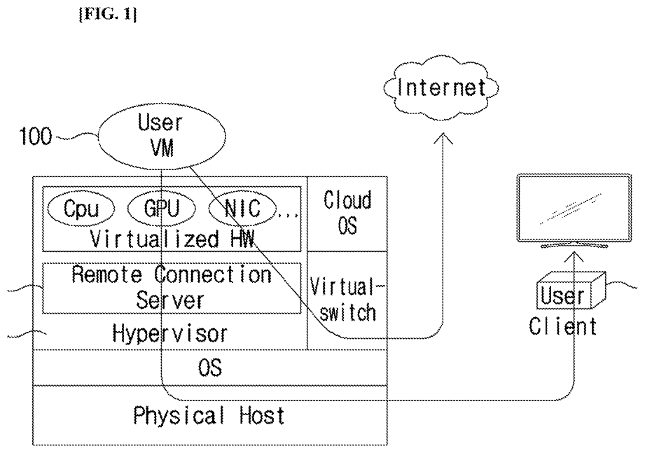

FIG. 2 illustrates a VM screen transmission method using the HW GPU virtualization technology capable of being applied to the present invention;

FIGS. 3A and 3B are flowcharts illustrating a virtual screen transmission method according to a first embodiment of the present invention;

FIG. 4 illustrates a method and apparatus for transmitting a virtual screen according to a second embodiment of the present invention;

FIG. 5 is a view illustrating VM screen transmission according to the network forwarding applied to a second embodiment of the present invention;

FIG. 6 is a flowchart illustrating a second embodiment according to the present invention;

FIG. 7 is a flowchart illustrating a virtual screen transmission method according to a third embodiment of the present invention; and

FIG. 8 is a flowchart of selectively utilizing the first embodiment and the second embodiment according to another embodiment of the present invention.

### DETAILED DESCRIPTION OF THE INVENTION

Hereinbelow, embodiments of the present invention will be described in detail so that those skilled in the art can easily carry out the present invention referring to the accompanying drawings. However, the present disclosure may be embodied in many different forms and is not limited to the embodiments described herein.

In the following description of the embodiments of the present invention, a detailed description of known functions and configurations incorporated herein will be omitted when it may make the subject matter of the present disclosure unclear. Parts not related to the description of the present disclosure in the drawings are omitted, and similar parts are denoted by similar reference numerals.

In the present disclosure, components that are distinguished from one another are intended to clearly illustrate each feature and do not necessarily mean that components are separate. That is, a plurality of components may be integrated into one hardware or software unit, or a single component may be distributed into a plurality of hardware or software units. Accordingly, such integrated or distributed embodiments are also included within the scope of the present disclosure, unless otherwise noted.

In the present disclosure, the components described in the various embodiments do not necessarily mean essential components, but some may be optional components. Accordingly, embodiments consisting of a subset of the components described in an embodiment are also included within the scope of this disclosure. Also, embodiments that include other components in addition to the components described in the various embodiments are also included in the scope of the present disclosure.

Hereinafter, embodiments of the present disclosure will be described with reference to the accompanying drawings.

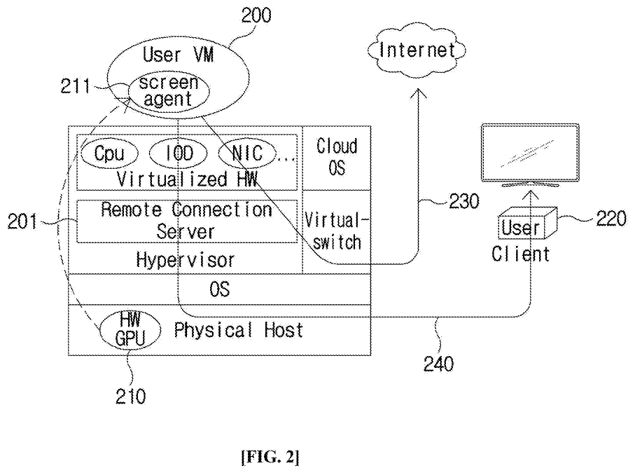

FIG. 2 illustrates a method of transmitting a screen of a virtual machine (VM) (hereinafter, referred to “VM screen transmission method”) using a HW GPU virtualization technology capable of being applied to the present invention.

For example, referring to FIG. 2, in order to transmit the screen of a VM 200 that uses a HW GPU 210 to a remote user client 220, a method is generally used in which a virtual server is created in the user VM 200 to transmit a remote screen and thus an external client is connected to the corresponding virtual server. For example, a remote desktop protocol (RDP) of Microsoft Corp. provides this method.

Referring to FIG. 2, it is necessary to transmit the screen of the GPU virtualized VM to the existing remote server 201. Such function is handled by a screen agent 211 in the VM 200. There may be various methods of transmitting the screen to the remote server 201 by the screen agent 211. For example, there is generally used a method of directly transmitting the screen over Internet, such as connection 230 in FIG. 2, over a TCP network. However, there is a problem that this method is vulnerable to security risks, because a network of the VM is strictly separated from a network of the physical host due to security management characteristic in the cloud.

As another method of transmitting the screen, the VM 200 is connected to the remote server 201 through a virtualized special I/O device (IOD) like a connection 240 of FIG. 2 so that the screen transmission may be performed via the connection. For example, as a device that may be used as a virtual IO device (IOD), there is a VirtIO-Serial device supported by a KVM/QEMU hypervisor. In this regard, since the connection 240 is not an external Internet direct connection like the connection 230 mentioned above, the connection 240 is more superior in security, but a virtual device is used at the time of implementation so that a system is complicated and thus stability decreases.

Accordingly, the present invention proposes various methods for efficiently transmitting a virtual screen of a GPU virtualized VM. In particular, the present invention discloses a first embodiment for efficiently transmitting a VM virtual screen by utilizing a screen coding scheme conversion and a second embodiment for efficiently transmitting a virtual screen of the VM through a host IP access. Herein, the first embodiment and the second embodiment may be utilized independently of each other, and they may be integrated to be utilized as a third embodiment. Hereinafter, each embodiment will be described in detail.

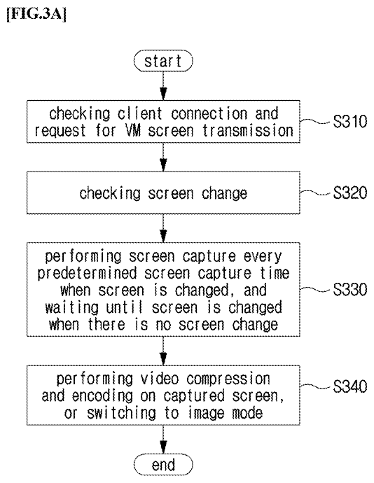

FIGS. 3A and 3B are flowcharts illustrating a virtual screen transmission method according to a first embodiment of the present invention. In this regard, FIGS. 3A and 3B correspond to the first embodiment of the present invention, in which a method of optimally transmitting data of a virtual screen is described. Particularly, FIG. 3A relates to a data encoding method according to a screen change, and FIG. 3B relates to a method of adjusting a dynamic frame transmission rate from the number of buffered frames in a transmission buffer.

For example, when a virtual screen composed of video screens is transmitted without compressing the original screen data, it is obvious that the amount of data increases, a network load is caused, and performance that a user feels is decreased. Accordingly, in order to solve such problems when typically transmitting the video screen, it is possible to reduce the amount of network transmission data by compressing and encoding the video in real time.

However, in order to compress and encode the video, there are problems that a large amount of CPU or other computing resources are consumed, and image quality degradation may occur during compression of the video. Therefore, there is a need for a method of further optimizing the transmission of the virtual screen.

Referring to FIG. 3A, the screen agent 211 described above checks whether a client is connected and whether the connected client makes a request for VM screen transmission (S310). As a result of the checks in the step S310, when the connected client makes the request for the VM screen transmission, checking whether or not the screen is changed (S320). Hereinafter, the step S320 will be described in detail.

For example, in the case of video compression and transmission, FPS (frame/second) is used as a transmission speed. For example, 30 FPS means that 30 frames are captured per second so that the video is compressed and transmitted. In this case, according to the set FPS value, the screen capture may occur at an interval of 1000/FPS millisecond (ms). That is, for example, when the video is transmitted at 30 FPS, it means that the screen is captured about every 33 ms. Therefore, in this case, the checking of whether or not the screen is changed in the step S320 is preferably performed after 1000/FPS ms or more elapses from the time when the previous screen is captured.

In addition, although the screen change of a screen to be transmitted does not occur for, for example, one second, when the screen is captured and transmitted every 33 ms, it corresponds to a waste of resources. Particularly, it is obvious that resource waste should be reduced when transmitting a virtual screen generated by the virtualized HW GPU, which is to be solved by the present invention.

Therefore, in order to save resources and efficiently transmit the video, the screen capture is performed every a predetermined screen capture time (T, for example, at least 33 ms) when there is any screen change, and the process waits until the screen is changed when there is no screen change (S330).

According to the determination in the step S330, since transmitting the screen only using the video compression and encoding causes waste of resources, the video compression and encoding transmission is performed on the captured screen, only when the screen change occurs rapidly, such as when the user is watching a video on the actual screen, or when the user is playing a game, and otherwise, switching to the image mode is performed so that the original screen image is transmitted as it is, or the still image screen is transmitted according to still image compression (S340).

Referring to FIG. 3B, when performing the transmission step S340, a method of adjusting the dynamic frame transmission rate from the number of buffered frames in the transmission buffer is related. That is, when performing the video compression and encoding transmission every a predetermined screen capture time T, the number of frames stored in the buffer storing video compression frames sent from the server to the terminal is checked (S350). For example, when the number of frames that are not yet transmitted due to network or terminal performance problems and stored in the buffer is equal to or greater than a predetermined integer value B, the predetermined screen capture time T is increased by M times (S360). On the other hand, when there are no frames stored in the buffer (for example, the number of frames is zero) and the predetermined screen capture time T is larger than the predetermined reference value TO, the screen capture time T is reduced by a certain unit (e.g., 1) (S370). Therefore, it becomes possible to adjust the dynamic frame transmission rate according to the number of frames stored in the buffer. In addition, it is preferable that the checking of whether the screen is changed and the checking of buffer size (S350-S370) are performed at least after the determined screen capture time T or more elapses from the time when the previous screen is captured.

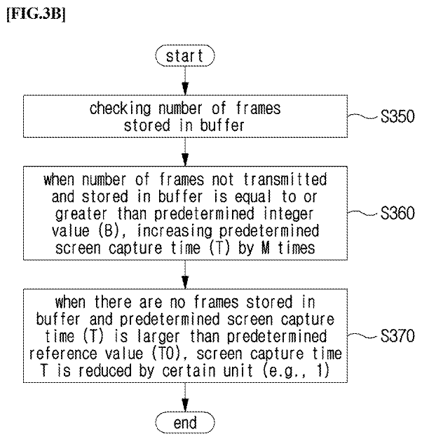

FIG. 4 illustrates virtual screen transmission method and apparatus according to a second embodiment of the present invention. In this regard, FIG. 4 is a diagram illustrating a method of transmitting virtual screen data using a host IP according to a second embodiment of the present invention.

In this regard, the second embodiment of the present invention proposed in FIG. 4 relates to a method of transmitting a virtual screen of a GPU virtualized VM to a client by reusing an existing remote server, without using an external network of a VM having security risk and also without using a special virtualized input/output device (IOD).

Referring to FIG. 4, network forwarding setting is performed between the virtualized NIC 403 of the VM 400 and the host NIC 407 of the actual physical host server executing the corresponding VM. Accordingly, a connection channel 410 connecting the screen agent 401 and the user client 420 is generated according to the network forwarding setting, and the VM screen transmission is performed through the corresponding channel 410. That is, according to the method in the related art, external connection is made only through a public IP allocated to the NIC of the VM, whereby there are problems that it is not only vulnerable to a security problem, but also the public IP, which is a valuable resource to the VM, has to be assigned to a VM screen transmission. Accordingly, when the connection path 410 according to the second embodiment of the present invention is applied, since the existing IP of the host is reused and connected, it is possible to save resources and solve security problems.

Specifically, to forward the IP of the physical host and the NIC IP of the virtual machine, for example, a port forwarding function supported by the QEMU hypervisor 409 (hypervisor) may be used. For example, using the QEMU hypervisor, which is one of the most representative and widely used hypervisors for executing a VM, it is possible to perform a network function as in Equation 1 below.

device e1000, netdev=net

netdev user, id=net0, hostfwd=tcp::5555-:22 (Equation 1)

In Equation 1, the first line creates a virtual physical network termed net0, and creates a virtual device e1000 type used by the VM in the network. The second line in Equation 1 creates a virtual TCP/IP network of a user type at the corresponding net0 and serves to forward the TCP port 5555 of the host to the IP port 22 of the VM.

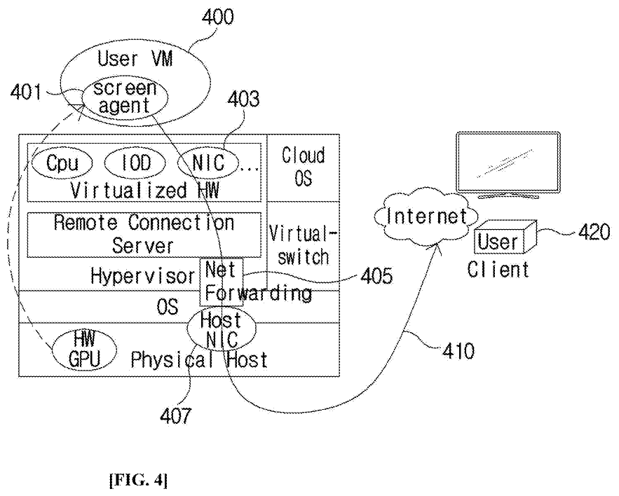

For example, when the command according to Equation 1 is executed, a virtual network as shown in FIG. 5 may be created. Referring to FIG. 5, the TCP port 555 connected to a host network is connected to port 22 of 10.0.2.15 on the guest OS of the VM. Here, the network forwarding method may be variously implemented according to a network scheme to which the present invention is applied.

Referring to FIG. 5, when an external user client makes a connection to the forwarded port 5555 of the host, the corresponding network connection is automatically made to port 22 which the screen transmission agent server in the window of the virtual VM is waiting to be connected. As a result, the external user client may access the virtual screen transmission server and receive the screen of the GPU virtualized VM.

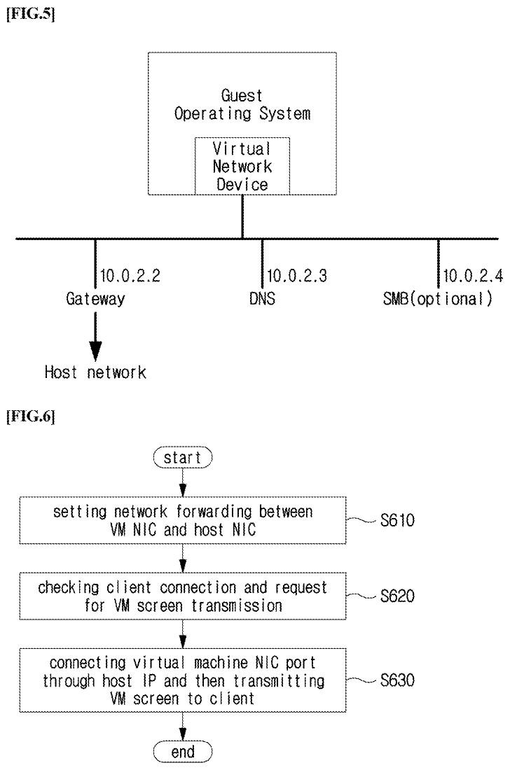

FIG. 6 is a flowchart illustrating a second embodiment according to the present invention. Referring to FIG. 6, the screen agent 401 first sets network forwarding between a virtualized network interface card (NIC) in the virtual machine and a host network interface card (NIC) of the device in which the virtual machine is installed (S610). The specific method of the network forwarding may be set, for example, in the same manner as described above. However, it is obvious that this is only one example of use, and there may be various network forwarding methods.

Then, it is checked whether or not the client is connected, and it is checked whether the connected client makes a request for VM screen transmission (S620). When it is determined in step S620 that the connected client makes the request for the VM screen transmission, the virtual machine NIC port is connected through the host IP determined according to the set network forwarding, and then the VM screen is transmitted to the client (S630).

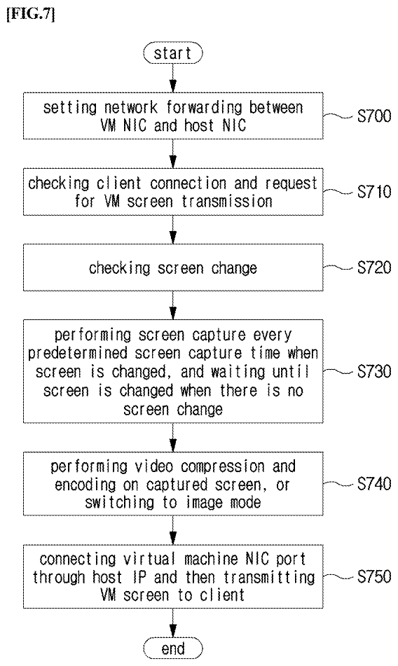

FIG. 7 is a flowchart illustrating a virtual screen transmission method according to a third embodiment of the present invention. In this regard, FIG. 7 shows a more efficient method by integrating the first embodiment (FIG. 3) and the second embodiment (FIG. 6) of the present invention described above.

Referring to FIG. 7, the screen agents 211 and 401 described above set network forwarding between a virtualized network interface card (NIC) in a virtual machine and a host network interface card (NIC) of a device in which the virtual machine is installed (S700). The network forwarding setting can be set in the same manner as the above-described example.

Then, it is confirmed whether or not the client is connected, and it is confirmed whether the connected client makes a request for VM screen transmission (S710). When it is determined in step S710 that the connected client makes the request for the VM screen transmission, it is checked whether the screen is changed first (S720). The step S720 performs substantially the same operation as the step S320.

Accordingly, as a result of determination in the step S720, when the screen is changed, the screen capture is performed every a predetermined screen capture time (e.g., 33 ms). When there is no screen change, the process waits until the screen is changed (S730).

According to the determination in the step S730, since transmitting the screen only using the video compression and encoding causes waste of resources, the video compression and encoding transmission is performed on the captured screen, only when the screen change occurs rapidly, such as when the user is actually watching the video on the screen, or when the user is playing the game, and otherwise, switching to the image mode is performed so that the original screen image is transmitted as it is, or the still image screen is transmitted according to still image compression (S740).

Thereafter, when either the capture screen or the image mode screen is determined as the VM screen to be transmitted in step S740, the actual transmission is performed by connecting the virtual machine NIC port through the host IP determined according to the set network forwarding and then transmitting the determined VM screen to be transmitted to the client (S750). The above-described method of the second embodiment of the present invention may be applied to step S750. Accordingly, the third embodiment of FIG. 7 corresponds to the method of applying both the first and second embodiments described above, and it becomes possible to further maximize the efficiency when transmitting the VM screen.

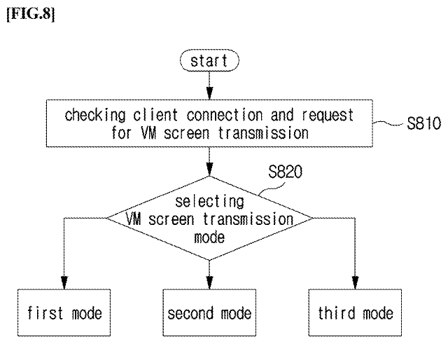

FIG. 8 is a flowchart of selectively utilizing the first embodiment and the second embodiment according to another embodiment of the present invention.

Referring to FIG. 8, the screen agents 211 and 401 check whether a client is connected, and check whether the connected client makes a request for VM screen transmission (S810).

As a result of checking in step S810, when the connected client makes the request for the VM screen transmission, the VM screen transmission mode is selected (step S820). The VM screen transmission mode may include an optimal encoding mode (first mode) according to the first embodiment (FIG. 3) described above, a host IP mode (second mode) according to the second embodiment (FIG. 6), and a mixed transmission mode (third mode) according to the third embodiment (FIG. 7).

In this regard, the selection of the VM screen transmission mode may be determined according to the characteristics of the VM screen. For example, when the maximum amount of data transmission is required, the third mode is selected, and when it is determined that the amount of data transmission is smaller than a reference value, the first mode or the second mode may be selectively determined.

In addition, according to the present invention, it is possible to select the VM screen mode in various determination methods, by determining the complexity of the virtual machine (VM) and whether the currently performed function is completely performed, in an overall manner.

Here, the first mode is performed according to the flowchart of FIG. 3 described above, the second mode is performed according to the flowchart of FIG. 6 described above, and the third mode is performed according to the flowchart of FIG. 7.

The various embodiments of the disclosure are not intended to be exhaustive of all possible combinations, but rather to illustrate representative aspects of the disclosure, and the features described in the various embodiments may be applied independently or in a combination of two or more.

In addition, various embodiments of the present disclosure may be implemented by hardware, firmware, software, or a combination thereof. In the case of hardware implementation, it may be implemented by one or more application specific integrated circuits (ASICs), digital signal processors (DSPs), digital signal processing devices (DSPDs), programmable logic devices (PLDs), field programmable gate arrays (FPGAs), a general processor, a controller, a microcontroller, a microprocessor, and the like.

The scope of the present disclosure includes software or machine-executable instructions (e.g., operating system, applications, firmware, program) that allow operations according to the various embodiments to be executable in device or computer, and a non-transitory computer-readable medium that is executable in the device or computer in which such software or instruction are stored.

It will be apparent to those skilled in the art that various modifications and variations can be made in the present invention without departing from the spirit or scope of the invention as defined in the appended claims, so the scope of the present invention are not limited by the embodiments and the accompanying drawings.

1. A method of transmitting a screen of a virtual machine(VM) using a hardware-based GPU, the method comprising:
checking whether a client is connected or not and whether or not the connected client makes a request for VM screen transmission;
checking whether or not the VM screen is changed when the connected client makes the request for the VM screen transmission;
performing screen capture every a predetermined screen capture time (T) when the VM screen is changed and a change rate per second of the corresponding screen is equal to or greater than a predetermined specific integer value (N); and
transmitting the captured screen using video compression and encoding.

2. The method of claim 1, further comprising:
when the change rate per second of the corresponding screen is less than the predetermined specific integer value (N), performing switching to an image mode, by which whenever an original screen is changed, the corresponding screen image is transmitted as it is.

3. The method of claim 1, wherein the transmitting of the captured screen using video compression and encoding is provided such that, when the number of frames that is not yet transmitted and stored in a buffer storing video compression frames is equal to or greater than a predetermined specific integer value (B), the predetermined screen capture time (T) is increased by M times, and when there is no frames stored in the buffer and the predetermined screen capture time (T) is larger than a predetermined reference value (T0), the screen capture time (T) is reduced by a predetermined unit.

4. The method of claim 1, wherein the checking of whether or not the screen is changed is performed after the predetermined capture time (T) or more elapses from a time when a previous screen is captured.

5. A method of transmitting a screen of a virtual machine (VM) using a hardware-based GPU, the method comprising:
creating a separate virtualized network interface card (VM MC) for virtual screen transmission in the virtual machine;
when creating a virtual network between the separate virtualized network interface card (VM NIC) in the virtual machine and a host network interface card (NIC) of a device in which the virtual machine is installed, setting network forwarding between the host NIC and the VM NIC in the corresponding network;
checking whether a client is connected or not and whether or not the connected client makes a request for VM screen transmission; and
transmitting the VM screen according to the set network forwarding, when the connected client makes the request for the VM screen transmission.

6. The method of claim 5, wherein the setting of the network forwarding is performed without using an external network of the virtual machine having security risk.

7. The method of claim 6, wherein the setting of the network forwarding is performed without using a public IP allocated to the virtualized network interface card (NIC) in the virtual machine.

8. The method of claim 5, wherein the setting of the network forwarding uses a port forwarding function supported by a hypervisor in the virtual machine.

9. The method of claim 5, wherein the transmitting of the VM screen includes:
when the connected client makes the request for the VM screen transmission, checking whether or not the screen is changed;
performing screen capture every a predetermined screen capture time when the screen is changed, and waiting until the screen is changed when there is no screen change; and
performing video compression and encoding on the captured screen and transmitting the screen of the compressed and encoded video according to the set network forwarding.

10. A method of transmitting a screen of a virtual machine (VM) using a hardware-based GPU, the method comprising:
checking whether a client is connected or not and whether or not the connected client makes a request for VM screen transmission; and
when the connected client makes the request for the VM screen transmission, selecting any one of an optimal encoding mode (first mode), a host IP mode (second mode), and a mixed transmission mode (third mode) as a VM screen transmission mode.

11. The method of claim 10, wherein the first mode is provided by, when the connected client makes the request for the VM screen transmission, repeating procedures of checking whether the screen is changed, performing screen capture every a predetermined screen capture time (T) when the screen is changed, and waiting until the screen is changed when there is no screen change, so that the only captured screen is transmitted using video compression and encoding.

12. The method of claim 10, wherein the second mode is provided by setting network forwarding between a virtualized network interface card (NIC) in the virtual machine and a host network interface card (NIC) of a device in which the virtual machine is installed, and transmitting the VM screen according to the set network forwarding when the connected client makes the request for VM screen transmission.

13. The method of claim 10, wherein the third mode is provided by setting network forwarding between a virtualized network interface card (NIC) in the virtual machine and a host network interface card (NIC) of a device in which the virtual machine is installed, repeating procedures of checking whether the screen is changed or not, performing screen capture every a predetermined screen capture time (T) when the screen is changed, and waiting until the screen is changed when there is no screen change when the connected client makes the request for the VM screen transmission, and performing video compression and encoding on the captured screen and transmitting the screen of the compressed and encoded video according to the set network forwarding.

14. The method of claim 10, wherein the selecting of the VM screen transmission mode is performed by determining the VM screen transmission mode according to an amount of data to be transmitted.
